(19) United States
(12) Patent Application Publication
(10) Pub. No.: US 2026/0106645 A1
(43) Pub. Date: Apr. 16, 2026

(54) ACCESS POINT IDENTIFIER ASSIGNMENT IN COORDINATED COMMUNICATION SCHEMES

(71) Applicant: QUALCOMM Incorporated, San Diego, CA (US)

(72) Inventors: Giovanni CHISCI, San Diego, CA (US); Abhishek Pramod PATIL, San Diego, CA (US); Gaurang NAIK, San Diego, CA (US); Sanket Sanjay KALAMKAR, San Diego, CA (US); Sherief HELWA, San Diego, CA (US); Alfred ASTERJADHI, San Diego, CA (US); Sai Yiu Duncan HO, San Diego, CA (US); George CHERIAN, San Diego, CA (US)

(21) Appl. No.: 18/916,532

(22) Filed: Oct. 15, 2024

(51) Int. Cl. H04B 7/024

(52) U.S. Cl. CPC H04B 7/024

(57) ABSTRACT

This disclosure provides methods, components, devices and systems for access point (AP) identifier (ID) assignment in coordinated communication schemes. A first access point transmit a first frame that includes a first set of fields. The first set of fields may include a first field proposing an identifier associated with a second AP for a coordinated AP (CAP) scheme, which may include the first AP and at least the second AP. The first AP may receive a second frame that includes a second set of fields. The second set of fields may have a second field including an indication of whether the second AP accepts the ID associated with the second AP for the CAP scheme. The first AP may communicate with one or more wireless stations (STAs) in accordance with the CAP scheme and the second frame.

### TECHNICAL FIELD

This disclosure relates generally to wireless communication and, more specifically, to access point (AP) identifier assignment in coordinated communication schemes.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure may be implemented in a method for wireless communications by a first access point (AP). The method may include transmitting a first frame including a first set of multiple fields, where the first set of multiple fields includes a first field proposing an identifier associated with a second AP for a coordinated AP scheme including the first AP and at least the second AP, receiving, in accordance with transmitting the first frame, a second frame including a second set of multiple fields, where the second set of multiple fields includes a second field including an indication of whether a second AP accepts the identifier associated with the second AP for the coordinated AP scheme, and communicating with one or more STAs, the second AP, or both in accordance with the coordinated AP scheme and the second frame.

Another innovative aspect of the subject matter described in this disclosure can be implemented in a first AP for wireless communications. The first AP may include a processing system that includes processor circuitry and memory circuitry that stores code. The processing system may be configured to cause the first AP to transmit a first frame including a first set of multiple fields, where the first set of multiple fields includes a first field proposing an identifier associated with a second AP for a coordinated AP scheme including the first AP and at least the second AP, receive, in accordance with transmitting the first frame, a second frame including a second set of multiple fields, where the second set of multiple fields includes a second field including an indication of whether a second AP accepts the identifier associated with the second AP for the coordinated AP scheme, and communicate with one or more STAs, the second AP, or both in accordance with the coordinated AP scheme and the second frame.

Another innovative aspect of the subject matter described in this disclosure can be implemented in a first AP for wireless communications. The first AP may include means for transmitting a first frame including a first set of multiple fields, where the first set of multiple fields includes a first field proposing an identifier associated with a second AP for a coordinated AP scheme including the first AP and at least the second AP, means for receiving, in accordance with transmitting the first frame, a second frame including a second set of multiple fields, where the second set of multiple fields includes a second field including an indication of whether a second AP accepts the identifier associated with the second AP for the coordinated AP scheme, and means for communicating with one or more STAs, the second AP, or both in accordance with the coordinated AP scheme and the second frame.

Another innovative aspect of the subject matter described in this disclosure can be implemented in a non-transitory computer-readable medium storing code for wireless communications. The code may include instructions executable by one or more processors to transmit a first frame including a first set of multiple fields, where the first set of multiple fields includes a first field proposing an identifier associated with a second AP for a coordinated AP scheme including the first AP and at least the second AP, receive, in accordance with transmitting the first frame, a second frame including a second set of multiple fields, where the second set of multiple fields includes a second field including an indication of whether a second AP accepts the identifier associated with the second AP for the coordinated AP scheme, and communicate with one or more STAs, the second AP, or both in accordance with the coordinated AP scheme and the second frame.

In some examples of the method, APs, and non-transitory computer-readable medium described herein, receiving the second frame may include operations, features, means, or instructions for receiving the second set of multiple fields via a first element of the second frame, receiving a third set of multiple fields via a second element of the second frame, where the third set of multiple fields includes a third field proposing a second identifier associated with the first AP for the coordinated AP scheme, the method further including, and transmitting, in accordance with receiving the second frame, a third frame including a fourth set of multiple fields, where the fourth set of multiple fields includes a fourth field including an indication of whether the first AP accepts the second identifier associated with the first AP for the coordinated AP scheme.

In some examples of the method, APs, and non-transitory computer-readable medium described herein, the second set of multiple fields further includes a third field proposing a second identifier associated with the first AP for the coordinated AP scheme and the method, apparatuses, and non-transitory computer-readable medium may include further operations, features, means, or instructions for transmitting, in accordance with receiving the second frame, a third frame including a third set of multiple fields, where the third set of multiple fields includes a fourth field including an indication of whether first AP accepts the second identifier associated with the first AP for the coordinated AP scheme.

In some examples of the method, APs, and non-transitory computer-readable medium described herein, the first set of multiple fields may be included in an element of the first frame that may be different than one or more elements of the first frame that correspond to one or more coordinated AP schemes and the second set of multiple fields may be included in an element of the second frame that may be different than one or more elements of the second frame that correspond to the one or more coordinated AP schemes.

In some examples of the method, APs, and non-transitory computer-readable medium described herein, the first set of multiple fields may be included as a sub-element of one or more elements of the first frame that correspond to one or more coordinated AP schemes and the second set of multiple fields may be included as a sub-element of one or more elements of the second frame that correspond to the one or more coordinated AP schemes.

In some examples of the method, APs, and non-transitory computer-readable medium described herein, transmitting the first frame may include operations, features, means, or instructions for transmitting the first set of multiple fields via a first element of the first frame, where the first set of multiple fields includes a third field including an indication of an element type associated with the first element, or includes a fourth field including an indication of whether the first element may be associated with the AP, or with the second AP, or both.

Some examples of the method, APs, and non-transitory computer-readable medium described herein may further include operations, features, means, or instructions for incrementing a counter value associated with transmitting the first frame, the counter value indicative of a quantity of transmissions associated with assigning an identifier to the second AP, where the first set of multiple fields includes a third field including an indication of the counter value.

In some examples of the method, APs, and non-transitory computer-readable medium described herein, receiving the second frame may include operations, features, means, or instructions for receiving the second set of multiple fields via a first element of the second frame, where the second set of multiple fields includes a third field including an indication of a response type associated with the first element, and where the indication of whether the second AP accepts the identifier may be in accordance with the response type.

In some examples of the method, APs, and non-transitory computer-readable medium described herein, the response type includes an indication of an acceptance of an AP identifier for the coordinated AP scheme, an indication of a rejection of an AP identifier for the coordinated AP scheme, or an indication of a second identifier associated with the second AP for the coordinated AP scheme different than the identifier.

In some examples of the method, APs, and non-transitory computer-readable medium described herein, the first field including the identifier may be associated with at least a portion of a third field associated with one or more association identifiers corresponding to the one or more STAs.

Some examples of the method, APs, and non-transitory computer-readable medium described herein may further include operations, features, means, or instructions for generating a value of the identifier associated with the second AP for the coordinated AP scheme prior to transmitting the first frame, where the value of the identifier may be different than one or more values associated with the one or more STAs, or the value at least partially matches a basis service set (BSS) color value associated with the second AP, or the value at least partially matches a BSS identifier of the second AP, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless access point (AP) and one or more wireless stations (STAs).

FIG. 3 shows an example of a signaling diagram that supports AP identifier (ID) assignment in coordinated communication schemes.

FIG. 4 shows example frame structures that support AP ID assignment in coordinated communication schemes.

FIG. 5 shows an example of a process flow that supports AP ID assignment in coordinated communication schemes.

FIG. 6 shows a block diagram of an example wireless communication device that supports AP ID assignment in coordinated communication schemes.

FIGS. 7 and 8 show flowcharts illustrating example processes performable by or at a first access point (AP) that supports AP ID assignment in coordinated communication schemes.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, an access point (AP) may communicate with one or more other APs according to a coordinated AP (CAP) scheme (such as coordinated TDMA (CTDMA), coordinated spatial reuse (CSR), coordinated restricted target wake time (CRTWT), coordinated beamforming (CBF), and so on).

The CAP schemes may include, for example, techniques for participating APs to coordinate sharing of resources, such as parameters related to time resource sharing, frequency resource sharing, service period (SP) usage, and other coordination operations. In such techniques, a first AP may communicate (such as coordinate) with one or more other APs based on utilizing identifiers (IDs) that address the respective APs. However, in some cases, such methods may not provide mechanisms for the coordinating APs to assign (such as negotiate, determine, agree on) the IDs (such that each AP uses a unique ID) that each AP is to use for the coordination. For instance, one or more APs may utilize a same ID when performing a coordination operations, which may result in communication resource collisions, increased latency, and reduced communication quality in the wireless communication network.

Various aspects relate generally to one or more techniques for an AP to coordinate with one or more other APs when selecting an ID that is used for a CAP scheme. Some aspects more specifically relate to two or more APs exchanging of one or more frames that include an AP ID assignment element or sub-element (such as an element that includes a set of AP ID assignment fields, an AP-ID-Assignment-Element, an information element (IE)). For example, a first AP may transmit a first frame to a second AP that includes an AP ID assignment element. The element may include a field that indicates an ID (such as a proposed ID or a requested ID) for the second AP (such as or for the first AP). The second AP may respond by transmitting a second frame that includes one or more AP ID assignment elements. The AP ID assignment elements may include a field that indicates whether the second AP accepts the proposed ID, rejects the proposed ID, or proposes a different ID to be used by the second AP in the CAP scheme. Additionally, the second AP may transmit a frame to the first AP to propose an ID for the first AP (such as or for the second AP) in the CAP scheme, and the first AP may transmit another frame to accept, reject, or modify the proposal from the second AP. Accordingly, such mechanisms may enable the first AP and the second AP to coordinate on an ID assignment for each AP, which may support enhanced device coordination when communicating with one or more wireless stations (STAs) in accordance with the CAP scheme.

Particular aspects of the subject matter described in this disclosure can be implemented to realize one or more of the following potential advantages. In some examples, by transmitting a first frame that requests an AP ID (such as by including an AP ID assignment element or sub-element), the described techniques can be used to improve communication reliability, reduce latency, and mitigate communication collisions in accordance with using CAP schemes. For example, an AP may request an ID prior to performing communications using the ID, which may increase coordination between devices. Moreover, by transmitting a second frame that includes a response to the proposed ID in the first frame, two or more APs may cooperatively agree on which ID each AP is to use as part of the CAP scheme. Accordingly, the two or more APs may communicate using unique IDs during a CAP scheme, thus increasing spectral efficiency, improving communication reliability, and reducing latency in the wireless communications network.

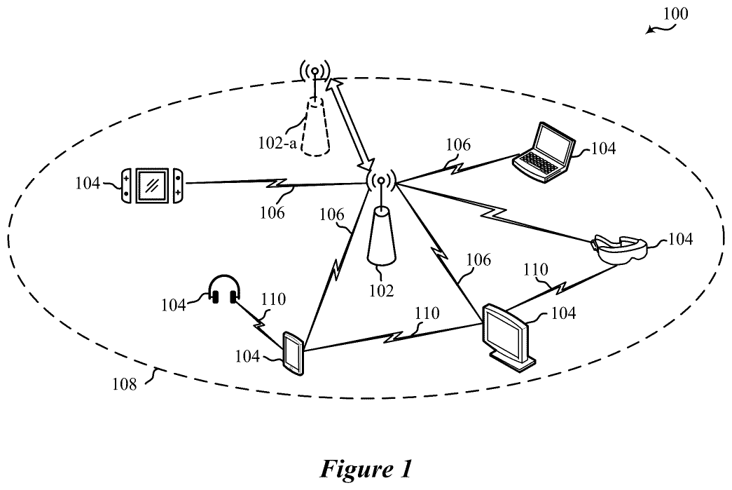

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions.

Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4 -1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmit opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples, in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some examples, the wireless communication network 100 may support CBF signaling. For instance, the CBF signaling may include a buffer state report poll (BSRP) trigger frame, which may be sent to indicate an intention of a sharing AP 102 to share its TXOP with a shared AP 102-a and to share other associated information. In some examples, the shared information may include a CAP Scheme (such as using 3 bits), which may be used to indicate that the information included in the BSRP Trigger frame is related to a CBF operation. In some examples, the shared information may include a CBF PPDU Duration (such as using 8 bits), which may be used to indicate a duration of the CBF PPDU in order for a shared AP 102-a to align its CBF PPDU with the PPDU of the sharing AP 102. In some examples, the shared information may include a quantity of STAs 104 (such as using 2 bits), which may indicate the quantity of STAs 104 that the sharing AP 102 schedules during the CBF TXOP. The shared information may further include an AID for each scheduled STA (such as STA 1 AID, STA 2 AID, . . . STA N AID, each using 12 bits). In some examples, the shared information may include a shared AP AID (such as APAID12, using 12 bits), which may be used to indicate shared AP-specific information. In some examples, the shared information may include Block ACK (BA) RU allocation (such as using 8 bits), which may indicate an RU assigned for the associated client of the shared AP 102-a to send their BA response frames.

In some examples, the wireless communication network 100 may support CSR signaling. For instance, the CSR signaling may include a BSRR trigger frame, which may be sent to indicate an intention of a sharing AP 102 to share its TXOP with a shared AP 102-a and to share other associated information. In some examples, the shared information may include a CAP Scheme (such as using 3 bits), which may be used to indicate that the information included in the BSRP Trigger frame is related to a CSR operation. In some examples, the shared information may include a CSR PPDU Duration (such as using 8 bits), which may be used to indicate a duration of the CSR PPDU in order for a shared AP 102-a to align its CSR PPDU with the PPDU of the sharing AP 102. In some examples, the shared information may include a shared AP AID (such as APAID12, using 12 bits), which may be used to indicate shared AP-specific information. In some examples, the shared information may include BA RU allocation (such as using 8 bits), which may indicate an RU assigned for the associated client of the shared AP 102-a to send their BA response frames. In some examples, the shared information may include a allocated transmission power (such as using 6 bits), which may indicate an allowed transmission power that is dictated to each shared AP 102-a separately.

As described herein, one or more APs 102 may utilize a CAP scheme, which may include each AP using an ID to perform coordinated communications (such as with other APs 102, with one or more STAs 104, or other devices). In some examples, two or more APs 102 may support a coordinated negotiation, signaling, and assignment of AP IDs for the CAP scheme. For example, a first AP 102 may transmit a first frame to a second AP 102 that includes a proposal (such as a request) for an ID that the second AP 102 uses (such as or an ID that the first AP uses) as part of the CAP scheme. The second AP 102 may respond by transmitting a second frame (such as a response frame) that includes a field indicating whether the second AP 102 accepts the proposed ID, rejects the proposed ID, or proposes a different ID. The second AP 102 may transmit a third frame (such as a second request frame) to the first AP to propose an ID that the first AP 102 uses (such as or an ID that the second AP uses) for the CAP scheme. Subsequently, the first AP 102 may respond by transmitting another frame (such as a second response frame) to accept, reject, or modify the proposal from the second AP 102. Accordingly, such mechanisms may enable the first AP 102 and the second AP 102 to coordinate on an ID assignment for each AP 102, which may enable enhanced device coordination when communicating with one or more STAs 104 in accordance with the CAP scheme.

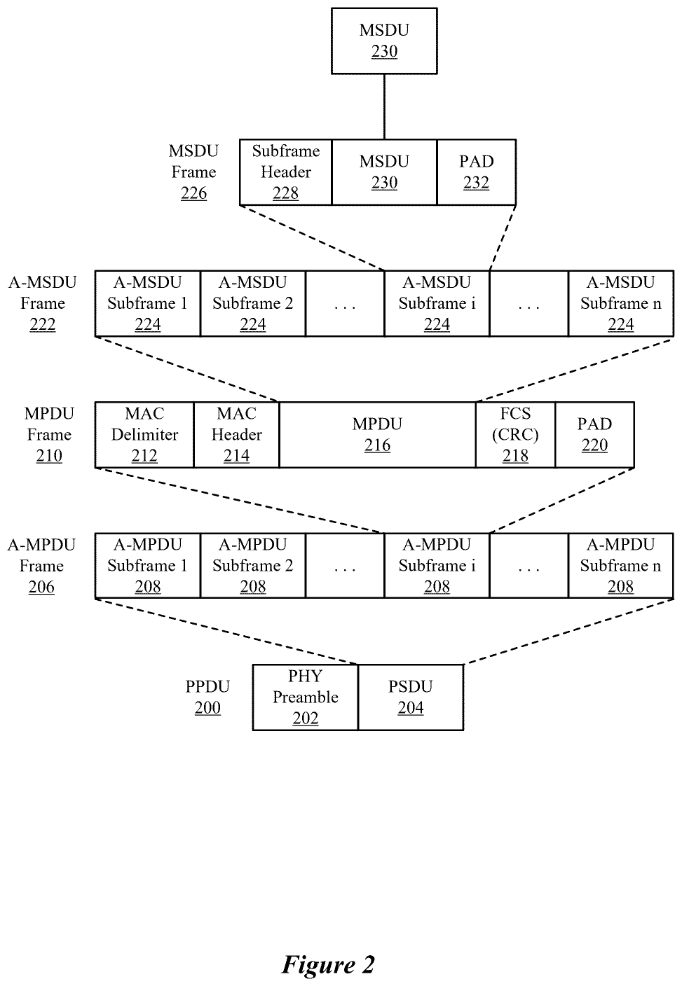

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some examples, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or BA of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”, such as a shared AP 102-a) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective AIDs, and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations.

Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as BSRP frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

As described herein, one or more APs 102 may support a coordinated ID assignment for a CAP scheme. In some examples, a first AP 102 may transmit a first frame to a second AP 102 that includes one or more fields associated with the ID assignment. For example, a field may include an ID (such as a proposed value) that the first AP 102 is requesting to use to address a second AP 102 (such as or an ID that the first AP 102 is requesting to use for itself) for the CAP scheme. The second AP 102 may receive the first frame and may respond by transmitting a second frame (such as a response frame) that also includes one or more ID assignment fields. For example, a field of the second fame may indicate whether the second AP 102 accepts, rejects, or proposes to modify the ID requested by the first AP 102. The second AP 102 also may transmit (such as via the second frame, or another frame) that requests an ID that the second AP 102 uses to address the first AP (such as or an ID that the first AP 102 is requesting to use for itself) for the CAP scheme. The first AP 102 may respond by transmitting another frame that accepts, rejects, or modifies the requested ID by the second AP 102. Accordingly, one or more APs 102 may support coordinated ID assignment techniques, which may ensure that each AP 102 uses a unique ID in the CAP scheme, thus enabling enhanced communication reliability and reduced latency.

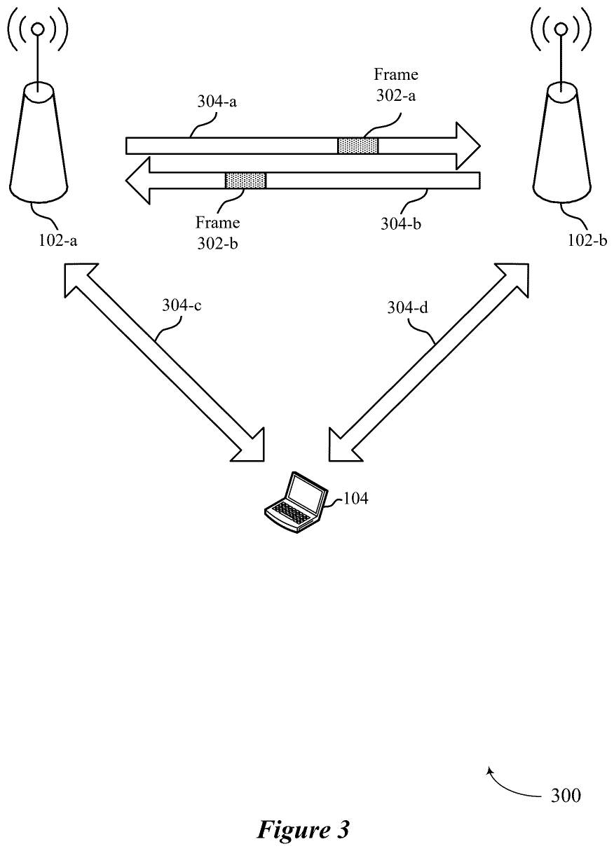

FIG. 3 shows an example of a signaling diagram 300 that supports AP ID assignment in coordinated communication schemes. The signaling diagram 300 may implement or may be implemented by aspects of the wireless communication network 100 or the PPDU 200. For example, the signaling diagram 300 may include one or more APs 102 (such as an AP 102-a and an AP 102-b) and one or more STAs 104, which may be examples of the corresponding devices as described with reference to FIG. 1. In some examples, the AP 102-a and the AP 102-b may comm

In some wireless communication systems, an AP 102-a may operate according to CAP schemes, as described with reference to FIG. 2. For example, the AP 102-a may communicate with a STA 104 via first resources (such as a first communication link) that has one or more subchannels overlapping (at least partially) with one or more subchannels used by an AP 102-b (or multiple other APs 012) to communicate with one or more additional STAs 104. The CAP techniques used by the AP 102-a may include CTDMA techniques in which the AP 102-a coordinates resources with the AP 102-b in a time domain. Additionally, or alternatively, the CAP techniques may include CSR techniques in which the AP 102-a coordinates resources with the AP 102-b in a spatial domain. Additionally, or alternatively, the CAP techniques may include CBF techniques in which the AP 102-a coordinates resources associated with beamforming with the AP 102-b. Additionally, or alternatively, the CAP techniques may include CRTWT techniques in which in which the AP 102-a coordinates resources with the AP 102-b regarding access to a wireless medium. The CAP techniques may, additionally, or alternatively, include one or more techniques related to coordination between APs 102.

In some examples, the signaling diagram 300 may support a framework for inter-AP communications for CAP sessions. Such techniques and mechanisms may be applied to any coordination feature including (but not limited to) CTDMA, CSR, CBF, and/or CRTWT. For instance, various structures may be used as containers for inter-AP communication. Such containers may be used to carry information to support the CAP protocols. The signaling diagram 300 also may support various procedures (which may form the basis of protocols) for CAP information exchange, which may support advertisement of CAP information and discovery, information gathering, and setup of CAP sessions. The exchange of information may be used for enablement/negotiation of CAP features, updates to CAP parameters, and teardown of CAP sessions. In some examples, to perform CAP techniques, the AP 102-a and the AP 102-b, may exchange information (such as parameters related to the CAP schemes) via frames 302 transmitted over communication links 304 (such as a communication link 304-a and a communication link 304-b). For instance, the AP 102-a may transmit information related to the CAP schemes to the coordinating APs (such as the AP 102-b) by including relevant fields or information elements (IEs) in frames 302 (such as beacon frames, broadcast probe response frames, dedicated CAP advertisement frames, or extended beacon frames).

In some examples, communications that occur during at least some CAP techniques may be based on addressing methods. That is, a frame exchange may be based on transmitting a frame that includes an address corresponding to an intended recipient AP 102 (or a STA 104). Such methods may thus support frame exchanges between the coordinating APs 102 and other devices during feature operation (such as including an address ID in each communicated frame). However, some CAP operations may not support mechanisms for coordinated determinations (such as negotiations, assignments, selections) of IDs for the coordinating APs 102. For instance, some methods may utilize a receiver address field or a BSSID field to address an AP 102 and such fields may not support an addressing of multiple APs 102 (such as for a CAP scheme with multiple APs 102). In some other cases, a method for assigning AIDs (such as for a STA 104) may include a utilization of one or more user info fields of one or more exchanged frames to determine the AID values, however, such methods may not include support for AP ID assignment.

In some examples, one or more frames 302 (such as containers) may be defined for communication of CAP information. For instance, multiple frames 102 may be defined (such as request frames, response frames, notification frames, and the like), which may include one or more elements that are specific to a particular CAP scheme (such as per-feature elements) for specific parameter negotiation (such as a CTDMA element or a CBF element). However, some elements may not include a mechanism for AP ID negotiation, which may lead to ambiguity at the APs 102 or the STA 104 during CAP scheme communications. For instance, the AP 102-a and the AP 102-b may select a same AP ID, resulting in undefined behavior in the system, ambiguous communication traffic, increased overhead and latency, and other effects.

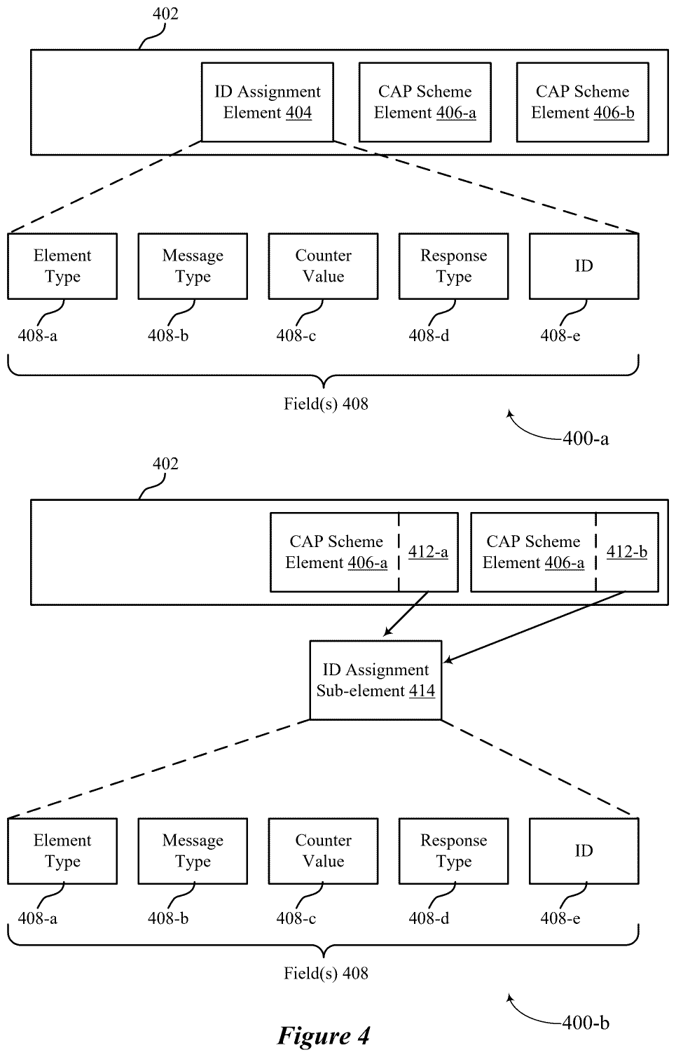

In accordance with one or more aspects described herein, an AP 102 (such as the AP 102-a) may support various techniques to coordinate (such as negotiate, signal, and assign) AP ID assignment with one or more other APs 102 (such as the AP 102-b). For example, the AP 102-a and the AP 102-b may support element structures within a frame 302 that facilitate the negotiation and assignment of an AP ID value for each AP 102 to use as part of CAP scheme communications. In some examples, an AP 102 may use (such as a frame 302 may include) a common CAP element for AP ID negotiation (such as common across, or applicable to, multiple CAP features or schemes that use it). Additionally, or alternatively, an AP 102 may use (such as a frame 302 may include) a feature specific (such as a CAP scheme specific) CAP sub-element element for AP ID negotiation. In such examples, the sub-element may be part of one or more elements specific to a give CAP scheme (such as a per-feature element, a CTDMA element, a CSR element, a CBF element, a CRTWT element, or some other CAP scheme element). Examples of such aspects are described in greater detail with reference to FIG. 4.

For example, the AP 102-a may transmit a frame 302-a to the AP 102-b. The frame 302-a may include multiple fields that are appliable to AP ID negotiation and assignment. At least one field in the frame 302-a may include an indication of a proposed ID for the AP 102-a to use to address the AP 102-b (such as an ID for the AP 102-b) for a CAP scheme (such as that includes the AP 102-a and the AP 102-b).

Alternatively, the indication may be of a proposed ID for the AP 102-a to use for itself for the CAP scheme. In response to transmitting the frame 302-a, the AP 102-a may receive a frame 302-b from the AP 102-b. The frame 302-b may include multiple fields that are appliable to the AP ID negotiation and assignment. For example, at least one field of the frame 302-b may include an indication of whether the AP 102-b accepts the ID proposed by the AP 102-a for the CAP scheme. Based on the exchange of frames 302, the AP 102-a and the AP 102-b may communicate with one or more STAs 104 (such as via a communication link 304-c or a communication link 304-d), with each other, with other APs 102, or any combination thereof in accordance with a CAP scheme. In some examples, “communicating” with another device (such as one or more STAs 104, one or more APs 102, or other devices) may refer to receiving a signal (such as a frame, a message) from the device, transmitting a signal to the device, or both.

In some examples, by including a common CAP element in a frame 302, the described techniques can be used to improve communication reliability and improve coordination between devices. For example, each frame 302 may include a separate field for AP ID negotiation that may be applied to each CAP scheme, thus improving the CAP scheme configuration with reduced impact to signaling overhead. In some examples, by including a CAP sub-element in each CAP scheme feature element, the devices may support a robust scheme in which each CAP scheme utilizes separate ID parameters, providing flexibility and additional control of the CAP scheme communications. Thus, by applying one or more aspects of the signaling diagram 300, a wireless communication network may support increased spectral efficiency, improving communication reliability, and reducing latency in the wireless communications network.

FIG. 4 shows an example of a frame structure 400-a and a frame structure 400-b that support AP ID assignment in coordinated communication schemes. The frame structures 400 may implement or may be implemented by aspects of the wireless communication network 100, the PPDU 200, and the signaling diagram 300. For example, the frame structures 400 may include a structure for a frame 402 (such as a CAP frame, a request frame, a response frame, a notification frame), which may be examples of a frame 302 or some other frame as described with reference to FIG. 1-3. That is, one or more APs 102 may support communication of one or more frames 402 in accordance with the frame structure 400-a, the frame structure 400-b, or a combination thereof.

The frame structure 400-a may illustrate an example of a common CAP element for AP ID negotiation (such as common across, or applicable to, multiple CAP features or schemes that use it). That is, the frame 402 may include an ID assignment element 404 (such as an AP ID assignment element, an AP ID element, an IE), which may be applicable to one or more CAP scheme elements 406 (such as the CAP scheme element 406 and the CAP scheme element 406-b). In some examples, two or more APs 102 may agree (such as a CTDMA agreement, a CBF agreement, a CSR agreement, or some other CAP scheme agreement) that each AP 102 uses AP IDs that are based on an outcome of a negotiation performed (such as carried out) via an exchange of one or more frames 402 (such as CAP frame exchanges) in accordance with the frame structure 400-a (such as based on including one or more ID assignment element 404).

In some examples, an AP ID assignment may be associated with an element (such as the ID assignment element 404) that can be included in one or more frames 402 (such as one or more CAP frames). In some examples, the content of the ID assignment element 404 may be applicable to one or more CAP schemes associated with a CAP scheme element 406-a (such as a CTDMA element) and a CAP scheme element 406-b (such as a CBF element). Although example quantities of ID assignment elements 404 and CAP scheme elements 406 are shown, the described techniques may be applied to any quantity of ID assignment elements 404 and CAP scheme elements 406. For example, the ID assignment element 404 may be applicable to the CAP scheme element 406-a, the CAP scheme element 406-b, and one or more other CAP scheme elements. In some examples, a frame 402 may include other elements (such as other IEs) associated with communications with one or more APs 102, one or more STAs 104, or other devices in accordance with aspects described herein.

The frame structure 400-b may illustrate an example of a feature specific CAP sub-element element for AP ID negotiation (such as a CAP scheme specific element). For example, an AP ID assignment may be a sub-element that may be included in a CAP scheme element 406 (such as a CTDMA element, a CBF element, a CSR element). That is, the frame 402 may include one or more CAP scheme elements 406 that each include a respective portion 412 allocated for an ID assignment sub-element 414 (such as an AP ID assignment sub-element, an AP ID sub-element, an IE). For example, the CAP scheme element 406-a may include a portion 412-a allocated for a first ID assignment sub-element 414, and the CAP scheme element 406-b may include a portion 412-b allocated for a second ID assignment sub-element 414 (such as including one or more different parameters than the first ID assignment sub-element 414).

In some examples, two or more APs 102 may agree (such as a CTDMA agreement, a CBF agreement, a CSR agreement, or some other CAP scheme agreement) that each AP 102 uses AP IDs that are specific to the per-feature negotiation (such as CAP frame exchanges) in accordance with the frame structure 400-b (such as based on including one or more ID assignment sub-elements 414 in each CAP scheme element 406). In some examples, the frame structure 400-b may provide flexibility, for example, in using a trigger frame for CAP scheme operation that specifies action for an AP 102 based on which AP ID is used (such as a BSRP triggering actions for one or more APs 102 called in one or more user info field, or an action that is determined by the AP ID).

In some examples, the ID assignment element 404 and/or the ID assignment sub-element 414 may include one or more fields 408 associated with AP ID assignment. For example, the fields 408 may include an element type field 408-a. The element type field 408-a may be associated with a code for AP ID assignment negotiation (which may be any value or indication). That is, the element type field 408-a may indicate (such as identify) that the element (the ID assignment element 404 or the first ID assignment sub-element 414) is associated with an AP ID assignment operation.

In some examples, the fields 408 may include a message type field 408-b. The message type field 408-b may include an indication of whether the ID assignment element 404 or the ID assignment sub-element 414 is associated with an outbound assignment (such as a proposed assignment for the AP 102 that transmits the frame 402) or an inbound assignment (such as a response to proposed assignment received from another AP). For example, the message type field 408-b may include a first value (such as 0) indicating that the ID assignment element 404 or the ID assignment sub-element 414 refers to an outbound assignment (such as a proposal for an ID), a second value (such as 1) indicating that the ID assignment element 404 or the ID assignment sub-element 414 refers to an inbound assignment (such as a response to a proposal), or some other value indicating some other message type.

In some examples, the fields 408 may include a counter value field 408-c. The counter value field 408-c may include an indication of a quantity of transmissions associated with assigning an ID to an AP 102. That is, the counter value field 408-c may indicate which iteration of the negotiation the ID assignment element 404 or the ID assignment sub-element 414 is associated with. For example, an AP 102 may increment a counter for each transmission (and/or reception) of a frame 402 that includes a ID assignment element 404 or a ID assignment sub-element 414, and the counter value field 408-c may indicate a value of the counter.

In some examples, the fields 408 may include a response type field 408-d. The response type field 408-d may include an indication of an acceptance of an AP ID, an indication of a rejection of an AP ID, or an indication of another proposal for an AP ID (such as a counter proposal). For example, the counter value field 408-c may include a first value (such as 0) indicating that an AP ID (such as received in a previous frame 402) is accepted, a second value (such as 1) indicating that the AP ID is rejected, a third value (such as 2) indicating that another AP ID is proposed for use, or one or more other values indicating other response types.

In some examples, the fields 408 may include an ID field 408-e (such as an AP ID field). The ID field 408-e may include an indication of a value (such as an address) associated with an AP ID. For example, when transmitting a frame 402, a first AP 102 may include a value for a proposed ID in the ID field 408-e. In some examples, the proposed ID may be an ID that the first AP 102 (such as a transmitting AP 102) proposes to use to address a second AP 102 (such as an ID associated with the second AP 102) in the CAP scheme. Alternatively, the proposed ID may be an ID that the first AP 102 proposes that other APs 102 use to address the first AP 102. Subsequently, a second AP 102 that receives the frame 402 may use the value of the ID field 408-e to determine whether the second AP 102 accepts, rejects, or proposes an alternative ID (such as via a response type field 408-d of a second frame 402), and may include the received ID value in a ID field 408-e of its response frame 402. In some examples, the ID field 408-e may include a second proposal for an ID (such as an alternative proposal or counter proposal) in response to receiving a first proposal (such as in accordance with indicating the third value in the ID field 408-e).

In some examples, a frame 402 may include multiple ID assignment elements 404 (or ID assignment sub-element 414). For example, an AP 102 may use a first ID assignment element 404 of a frame 402 to respond to a second AP 102 and may use a second ID assignment element 404 of the frame to propose its own ID to the second AP 102. Additionally, or alternatively, an AP 102 may use a same ID assignment element 404 (or ID assignment sub-element 414) to respond to a second AP 102 and to propose its own ID to the second AP (such as by including one or more additional fields 408).

As an illustrative example, an AP ID assignment negotiation (such as including an ID assignment element 404 and/or an ID assignment sub-element 414) may include a first AP 102 transmitting a first frame 402 to a second AP 102 (such as a first CAP frame, or an initial request to the second AP 102) that includes a first ID assignment element 404 or ID assignment sub-element 414 (such as a first AP-ID-Assignment-Element). An element type field 408-a of the first frame 402 may indicate that the element is an AP-ID-Assignment-Element, a message type field 408-b of the first frame 402 may indicate that the first frame 402 refers to an outbound assignment, a counter value field 408-c may indicate a value of 0, a response type field 408-d of the first frame 402 may indicate a reserved value (such as an empty value), and an ID field 408-e may indicate a value IDa.

A second AP 102 may transmit a second frame 402 based on receiving the first frame 402 (such as a second CAP frame in response to the initial request and over the reverse direction). The second frame may include a first ID assignment element 404 (or ID assignment sub-element 414) that responds to the first frame 402 (a response proposal) and a second ID assignment element 404 (an ID proposal by the second AP 102 to the first AP 102). For example, the first ID assignment element 404 (or ID assignment sub-element 414) of the second frame 402 may include an element type field 408-a that indicates that the element is an AP-ID-Assignment-Element, a message type field 408-b that indicates that the first ID assignment element 404 refers to an inbound assignment, a counter value field 408-c that indicates a value of 1, a response type field 408-d indicating that the IDa is accepted, and an ID field 408-e that indicates the value IDa. The second ID assignment element 404 (or ID assignment sub-element 414) of the second frame 402 may include an element type field 408-a that indicates that the element is an AP-ID-Assignment-Element, a message type field 408-b that indicates that the second ID assignment element 404 refers to an outbound assignment, a counter value field 408-c that indicates a value of 0, a response type field 408-d indicating a reserved value (such as an empty value), and an ID field 408-e that indicates a value IDb for the second AP 102. Additionally, or alternatively, the field values described for the first ID assignment element 404 and the second ID assignment element 404 may be included in a same ID assignment element 404 (or a same ID assignment sub-element 414).

Based on receiving the second frame 402, the first AP 102 may determine that its proposed ID was accepted (such as based on the first ID assignment element 404 of the second frame 402). In such examples, the first AP 102 may transmit an empty ID assignment element 404. Additionally, the AP 102 may transmit a third frame to respond to the proposal of the ID for the second AP 102 (such as based on the second ID assignment element 404 of the second frame 402). For example, an ID assignment element 404 (or ID assignment sub-element 414) of the third frame 402 may include an element type field 408-a that indicates that the element is an AP-ID-Assignment-Element, a message type field 408-b that indicates that the first ID assignment element 404 refers to an inbound assignment, a counter value field 408-c that indicates a value of 1, a response type field 408-d indicating that the IDb is accepted, and an ID field 408-e that indicates the value IDb. Accordingly, the first AP 102 may be assigned the IDa and the second AP 102 may be assigned the IDb.

In some examples, further frames 402 may be exchanged between APs 102 until each AP 102 agrees on the assignment (such as for both directions), or until it is determined that an agreement cannot be reached by the APs 102. For example, an exchange of frames 402 may continue until both a first AP 102 and a second AP 102 indicate an acceptance of an ID or until both the first AP 102 and the second AP 102 indicate a rejection of an ID (indicating a failure of the ID negotiation).

In some examples, an AP 102 may generate an address (such as a value) for the ID field 408-e in the ID assignment element 404 or the ID assignment sub-element 414 in accordance with various techniques. For example, the AP 102 may utilize a same space of clients (such as STAs 104) AID for the AP ID. That is, the AP 102 may reuse an AID field that is used for ID negotiation with one or more STAs 104. In some examples, the AP 102 may generate an address that is different than any AIDs of its clients. In some examples, the AP 102 may generate the address based on a BSS color (such as of one or more other APs 102, at least part of the address bits may match one or more bits of a BSS color). Additionally, or alternatively, the AP 102 may generate the address based on a BSSID (such as of one or more other APs 102, at least part of the address bits may match one or more bits of a BSSID).

In some examples, by including an ID assignment element 404 in a frame 402, the described techniques can be used to reduce ambiguity and reduce latency in CAP scheme-based communications. Moreover, by including a ID assignment sub-element 414 in a frame 402, the described techniques can be used to increase flexibility and robustness of the CAP schemes, resulting in enhanced device coordination and communication quality. Further, the fields 408 of the ID assignment element 404 or the ID assignment sub-element 414 may enable APs 102 to efficiently and accurately coordinate on respective IDs that are used during CAP schemes, which may mitigate resource collisions and reduce signaling overhead in a wireless communication network.

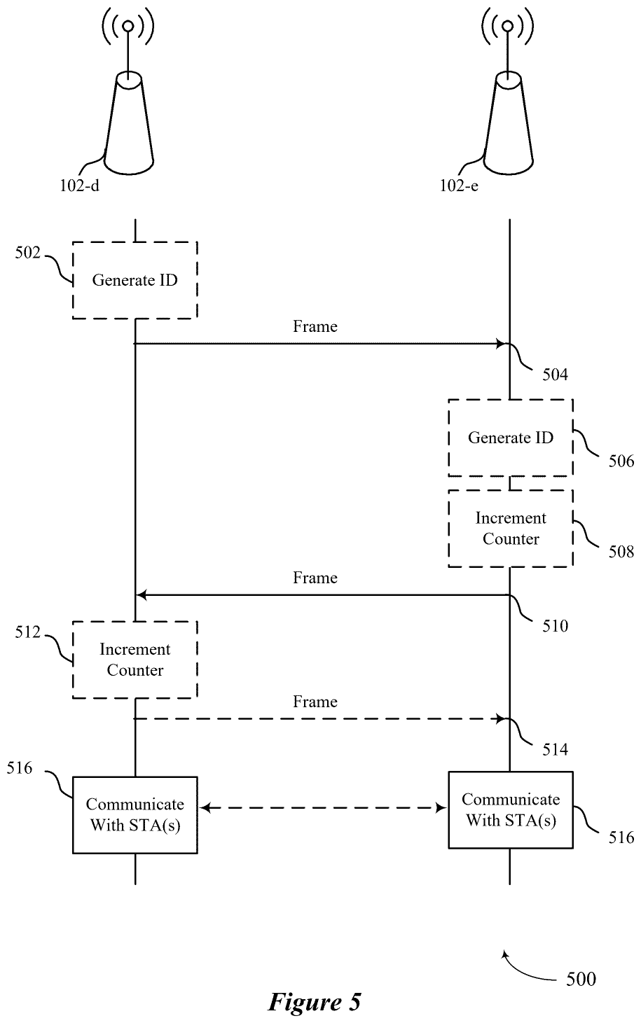

FIG. 5 shows an example of a process flow 500 that supports AP ID assignment in coordinated communication schemes. The process flow 500 may implement or may be implemented by aspects of the wireless communication network 100, the PPDU 200, the signaling diagram 300, or the frame structures 400. For example, the process flow 500 may be implemented by one or more APs 102 (such as an AP 102-d, an AP 102-e), which may be examples of the corresponding devices as described with reference to FIG. 1-4. In some examples, the AP 102-d and the AP 102-e (such as and one or more additional APs 102) may operate according to CAP schemes, as described with reference to FIG. 2-4. The CAP schemes may include a CTDMA scheme, a CSR scheme, a CRTWT scheme, a CBF scheme, or one or more other CAP schemes.

In the following description of the process flow 500, the operations between the AP 102-d and the AP 102-e may occur in a different order than the example order shown and in some examples may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 502, in some examples, the AP 102-d may generate a value (such as an address) of an ID associated with the AP 102-e (or an ID associated with the AP 102-d) for a CAP scheme prior to transmitting a first frame (such as a frame 302 or a frame 402). In some examples, the value of the ID may be different than one or more values associated with the one or more STAs 104 (such as STA(s) 104 associated with the AP 102-d). Additionally, or alternatively, the value may at least partially match a BSS color value associated with the AP 102-e. Additionally, or alternatively, or the value may at least partially match a BSSID of the AP 102-e. In some examples, the value may be generated in accordance with a combination of the described techniques.

At 504, the AP 102-d may transmit a first frame (such as a frame 302 or a frame 402). The first frame may include one or more fields (such as fields 408). The one or more fields may include a first field (such as an ID field 408-e) proposing an ID associated with the AP 102-e (or an ID associated with the AP 102-d) for a CAP scheme. In some examples, the first field including the ID may be associated with at least a portion of another field associated with one or more AIDs corresponding to the one or more STAs 104 (such as one or more STAs 104 associated with the AP 102-d). In some examples, the CAP scheme may include at least the AP 102-d and the AP 102-e. In some examples, the one or more fields may be included in an element of the first frame (such as a ID assignment element 404) that is different than one or more elements of the first frame that correspond to one or more CAP schemes (such as one or more CAP scheme elements 406). Additionally, or alternatively, the one or more fields may be included as a sub-element (such as a ID assignment sub-element 414) of one or more elements of the first frame that correspond to one or more CAP schemes (such as one or more CAP scheme element 406).

In some examples, the one or more fields may have a field including an indication of an element type associated with the element (such as an element type field 408-a). Additionally, or alternatively, the one or more fields may have a field including an indication of whether the element is associated with the AP 102-d or with the AP 102-e, or both (such as a message type field 408-b). Additionally, or alternatively, the one or more fields may have a field including an indication of a response type associated with the element. In some examples, the indication of whether an AP 102-e accepts an ID may be in accordance with (such as based on) the response type. In some examples, the response type may include an indication of an acceptance of an AP ID for the CAP scheme (such as a first value), an indication of a rejection of an AP ID for the CAP scheme (such as a second value), or an indication of a second ID associated with the AP 102-d for the CAP scheme different than the ID (such as a third value). Additionally, or alternatively, the one or more fields of a frame may have a field including an indication of the counter value that is associated with a quantity of transmissions for negotiating an ID.

At 506, in some examples, the AP 102-e may generate a value (such as an address) of an ID associated with the AP 102-d (or an ID associated with the AP 102-e) for a CAP scheme prior to transmitting a second frame (such as a frame 302 or a frame 402). In some examples, the value of the ID may be different than one or more values associated with the one or more STAs 104 (such as STA(s) 104 associated with the AP 102-e). Additionally, or alternatively, the value may at least partially match a BSS color value associated with the AP 102-d. Additionally, or alternatively, or the value may at least partially match a BSSID of the AP 102-d. In some examples, the value may be generated in accordance with a combination of the described techniques.

At 508, in some examples, the AP 102-e may increment a counter value associated with the first frame (such as based on receiving the first frame or based on transmitting a second frame in response to the first frame). In some examples, the counter value may be indicative of a quantity of transmissions associated with assigning an ID to the AP 102-d. In some examples, the one or more fields of a frame may have a field including an indication of the counter value.

At 510, the AP 102-d may receive, in accordance with (such as based on, in response to, after) transmitting the first frame, a second frame including one or more fields (such as one or more fields 408), which may be transmitted by the AP 102-e. In some examples, the fields of the second frame may have at least a field including an indication of whether the AP 102-e accepts the ID associated with the AP 102-e (or the with the AP 102-d) for the CAP scheme. Additionally, or alternatively, the fields of the second frame may include one or more other fields as described herein (such as including with reference to FIG. 4). In some examples, the AP 102-d may receive the fields (such as fields that are associated with a responsive frame to the first frame) of the second frame via a first element of the second frame. In some examples, the fields of the second frame also may include another field proposing a second ID associated with the AP 102-e for the CAP scheme. Additionally, or alternatively, the AP 102-d may receive another set of fields via a second element (such as a second ID assignment element 404 or a second ID assignment sub-element 414) of the second frame, and the other set of fields may include a field proposing a second ID associated with the AP 102-e for the CAP scheme (such as separate elements may be used to respond to a request and to propose another request).

In some examples, the one or more fields of the second frame may be included in an element (such as ID assignment element 404) of the second frame that is different than one or more elements of the second frame that correspond to the one or more CAP schemes (such as one or more CAP scheme elements 406). Additionally, or alternatively, the one or more fields may be included as a sub-element (such as ID assignment sub-element 414) of one or more elements of the second frame that correspond to the one or more CAP schemes (such as the one or more CAP scheme elements 406). In some examples, the AP 102-d may receive the one or more fields of the second frame via a first element of the second frame. In such examples, the one or more fields may have a third field including an indication of a response type associated with the first element. In some examples, the indication of whether the AP 102-e accepts the ID may be in accordance (such as based on) with the response type.

At 512, in some examples, the AP 102-d may increment a counter value associated with communicating (such as transmitting or receiving) the first frame, the second frame, a third frame, or any combination thereof (such as based on transmitting the first frame, or receiving the second frame, or transmitting a third frame). In some examples, the counter value may be indicative of a quantity of transmissions associated with assigning an ID to the AP 102-d.

At 514, in some examples, the AP 102-d may transmit, in accordance with (such as based on, in response to, after) receiving the second frame, a third frame including one or more fields (such as fields 408). In some examples, the fields of the third frame may have a fourth field including an indication of whether the AP 102-d accepts the second ID associated with the AP 102-d (or an ID associated with the AP 102-e) for the CAP scheme. Additionally, or alternatively, the fields of the third frame may include one or more other fields as described herein (such as including with reference to FIG. 4).

At 516, in some examples, the AP 102-d, the AP 102-e, or both may communicate with one or more STA 104 in accordance with the CAP scheme and the second frame (such as based on the one or more fields of the second frame, the first frame, the third frame, or other aspects of the process flow 500). Additionally, or alternatively, the AP 102-d and the AP 102-e may communicate with each other and/or with one or more other APs 102 in accordance with the CAP scheme.

In some examples, by exchanging one or more frames that include one or more fields associated with AP ID, the described techniques can be used to improve coordination between the AP 102-d and the AP 102-e. For example, the APs 102 may be enabled to ensure unique assignment of their respective IDs used for CAP schemes, resulting in enhanced communication reliability, reduced processing overhead, reduced ambiguity, and reduce latency. Moreover, the frame exchanging techniques may enable APs 102 to more-reliably assign AP IDs based on an ability to propose alternative ID address options for each AP 102. Thus, a wireless communications network may support enhanced communication quality, enhanced data rates, and enhanced spectral efficiency.

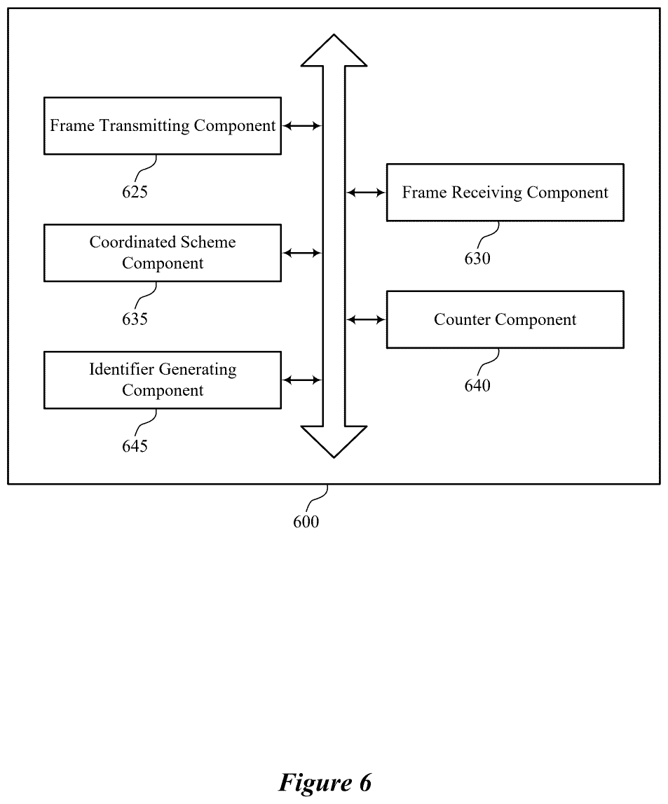

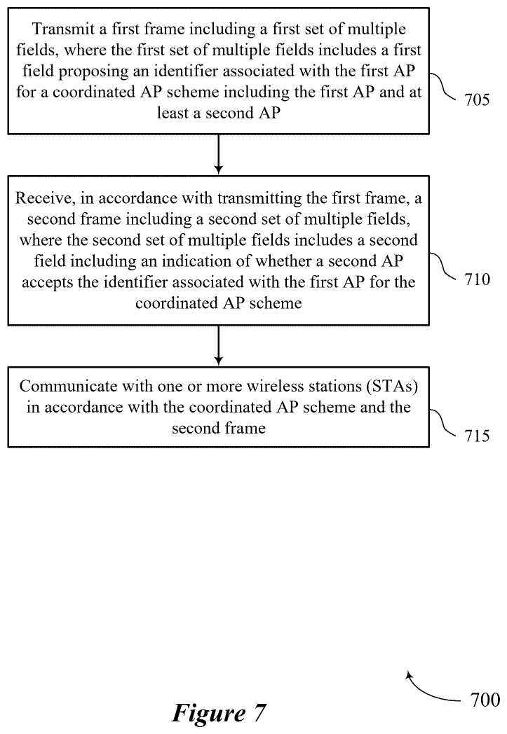

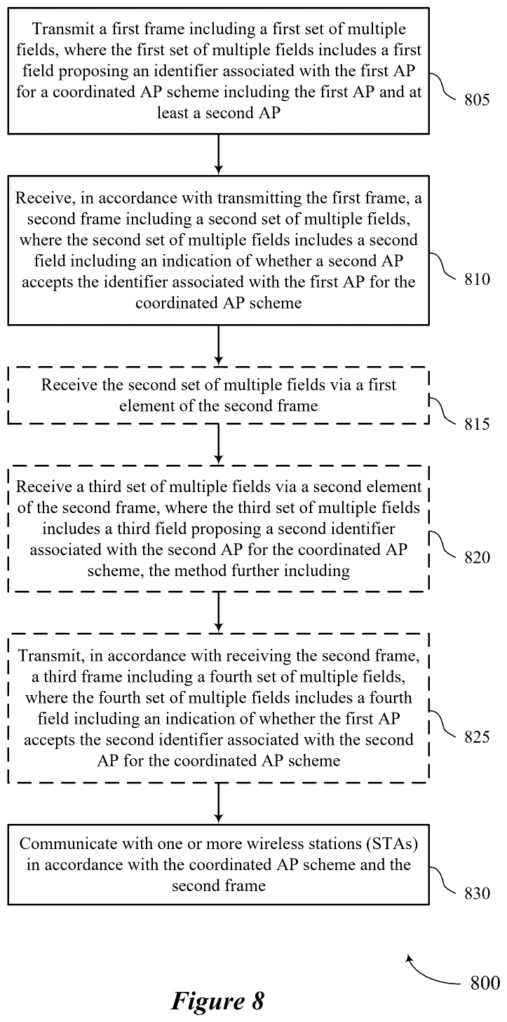

FIG. 6 shows a block diagram of an example wireless communication device 600 that supports AP ID assignment in coordinated communication schemes. In some examples, the wireless communication device 600 is configured to perform the processes 700 and 800 described with reference to FIGS. 7 and 8, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a frame transmitting component 625, a frame receiving component 630, a coordinated scheme component 635, a counter component 640, and an identifier generating component 645. Portions of one or more of the frame transmitting component 625, the frame receiving component 630, the coordinated scheme component 635, the counter component 640, and the identifier generating component 645 may be implemented at least in part in hardware or firmware. For example, one or more of the frame transmitting component 625, the frame receiving component 630, the coordinated scheme component 635, the counter component 640, and the identifier generating component 645 may be implemented at least in part by at least a processor or a modem. In some examples, portions of one or more of the frame transmitting component 625, the frame receiving component 630, the coordinated scheme component 635, the counter component 640, and the identifier generating component 645 may be implemented at least in part by a processor and software in the form of processor-executable code stored in memory.

The wireless communication device 600 may support wireless communications in accordance with examples as disclosed herein. The frame transmitting component 625 is configurable or configured to transmit a first frame including a first set of multiple fields, where the first set of multiple fields includes a first field proposing an identifier associated with a second AP for a coordinated AP scheme including the first AP and at least the second AP. The frame receiving component 630 is configurable or configured to receive, in accordance with transmitting the first frame, a second frame including a second set of multiple fields, where the second set of multiple fields includes a second field including an indication of whether the second AP accepts the identifier associated with the second AP for the coordinated AP scheme. The coordinated scheme component 635 is configurable or configured to communicate with one or more wireless stations (STAs), the second AP, or both in accordance with the coordinated AP scheme and the second frame.

In some examples, to support receiving the second frame, the frame receiving component 630 is configurable or configured to receive the second set of multiple fields via a first element of the second frame. In some examples, to support receiving the second frame, the frame receiving component 630 is configurable or configured to receive a third set of multiple fields via a second element of the second frame, where the third set of multiple fields includes a third field proposing a second identifier associated with the first AP for the coordinated AP scheme. In some examples, to support receiving the second frame, the frame transmitting component 625 is configurable or configured to transmit, in accordance with receiving the second frame, a third frame including a fourth set of multiple fields, where the fourth set of multiple fields includes a fourth field including an indication of whether the first AP accepts the second identifier associated with the first AP for the coordinated AP scheme.

In some examples, the second set of multiple fields further includes a third field proposing a second identifier associated with the first AP for the coordinated AP scheme, and the frame transmitting component 625 is configurable or configured to transmit, in accordance with receiving the second frame, a third frame including a third set of multiple fields, where the third set of multiple fields includes a fourth field including an indication of whether first AP accepts the second identifier associated with the first AP for the coordinated AP scheme.

In some examples, the first set of multiple fields is included in an element of the first frame that is different than one or more elements of the first frame that correspond to one or more coordinated AP schemes. In some examples, the second set of multiple fields is included in an element of the second frame that is different than one or more elements of the second frame that correspond to the one or more coordinated AP schemes.

In some examples, the first set of multiple fields is included as a sub-element of one or more elements of the first frame that correspond to one or more coordinated AP schemes. In some examples, the second set of multiple fields is included as a sub-element of one or more elements of the second frame that correspond to the one or more coordinated AP schemes.

In some examples, to support transmitting the first frame, the frame transmitting component 625 is configurable or configured to transmit the first set of multiple fields via a first element of the first frame, where the first set of multiple fields includes a third field including an indication of an element type associated with the first element, or includes a fourth field including an indication of whether the first element is associated with the AP, or with the second AP, or both.

In some examples, the counter component 640 is configurable or configured to increment a counter value associated with transmitting the first frame, the counter value indicative of a quantity of transmissions associated with assigning an identifier to the second AP, where the first set of multiple fields includes a third field including an indication of the counter value.

In some examples, to support receiving the second frame, the frame receiving component 630 is configurable or configured to receive the first set of multiple fields via a first element of the second frame, where the second set of multiple fields includes a third field including an indication of a response type associated with the first element, and where the indication of whether the second AP accepts the identifier is in accordance with the response type.

In some examples, the response type includes an indication of an acceptance of an AP ID for the coordinated AP scheme, an indication of a rejection of an AP ID for the coordinated AP scheme, or an indication of a second identifier associated with the second AP for the coordinated AP scheme different than the identifier.

In some examples, the first field including the identifier is associated with at least a portion of a third field associated with one or more association identifiers corresponding to the one or more STAs.

In some examples, the identifier generating component 645 is configurable or configured to generate a value of the identifier associated with the second AP for the coordinated AP scheme prior to transmitting the first frame, where the value of the identifier is different than one or more values associated with the one or more STAs, or the value at least partially matches a BSS color value associated with the first AP, or the value at least partially matches a BSSID of the second AP, or any combination thereof.

FIG. 7 shows a flowchart illustrating an example process 700 performable by or at a first AP that supports AP ID assignment in coordinated communication schemes. The operations of the process 700 may be implemented by a first AP or its components as described herein. For example, the process 700 may be performed by a wireless communication device, such as the wireless communication device 600 described with reference to FIG. 6, operating as or within a wireless AP. In some examples, the process 700 may be performed by a wireless AP, such as one of the APs 102 described with reference to FIG. 1.

In some examples, in 705, the first AP may transmit a first frame including a first set of multiple fields, where the first set of multiple fields includes a first field proposing an identifier associated with the second AP for a coordinated AP scheme including the first AP and at least a second AP. The operations of 705 may be performed in accordance with examples as disclosed herein. In some implementations, aspects of the operations of 705 may be performed by a frame transmitting component 625 as described with reference to FIG. 6.

In some examples, in 710, the first AP may receive, in accordance with transmitting the first frame, a second frame including a second set of multiple fields, where the second set of multiple fields includes a second field including an indication of whether the second AP accepts the identifier associated with the second AP for the coordinated AP scheme. The operations of 710 may be performed in accordance with examples as disclosed herein. In some implementations, aspects of the operations of 710 may be performed by a frame receiving component 630 as described with reference to FIG. 6.

In some examples, in 715, the first AP may communicate with one or more wireless stations (STAs) in accordance with the coordinated AP scheme and the second frame. The operations of 715 may be performed in accordance with examples as disclosed herein. In some implementations, aspects of the operations of 715 may be performed by a coordinated scheme component 635 as described with reference to FIG. 6.

FIG. 8 shows a flowchart illustrating an example process 800 performable by or at a first AP that supports AP ID assignment in coordinated communication schemes. The operations of the process 800 may be implemented by a first AP or its components as described herein. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in 805, the first AP may transmit a first frame including a first set of multiple fields, where the first set of multiple fields includes a first field proposing an identifier associated with the second AP for a coordinated AP scheme including the first AP and at least a second AP. The operations of 805 may be performed in accordance with examples as disclosed herein. In some implementations, aspects of the operations of 805 may be performed by a frame transmitting component 625 as described with reference to FIG. 6.

In some examples, in 810, the first AP may receive, in accordance with transmitting the first frame, a second frame including a second set of multiple fields, where the second set of multiple fields includes a second field including an indication of whether the second AP accepts the identifier associated with the second AP for the coordinated AP scheme. The operations of 810 may be performed in accordance with examples as disclosed herein. In some implementations, aspects of the operations of 810 may be performed by a frame receiving component 630 as described with reference to FIG. 6.

In some examples, in 815, the first AP may receive the second set of multiple fields via a first element of the second frame. The operations of 815 may be performed in accordance with examples as disclosed herein. In some implementations, aspects of the operations of 815 may be performed by a frame receiving component 630 as described with reference to FIG. 6.

In some examples, in 820, the first AP may receive a third set of multiple fields via a second element of the second frame, where the third set of multiple fields includes a third field proposing a second identifier associated with the first AP for the coordinated AP scheme. The operations of 820 may be performed in accordance with examples as disclosed herein. In some implementations, aspects of the operations of 820 may be performed by a frame receiving component 630 as described with reference to FIG. 6.

In some examples, in 825, the first AP may transmit, in accordance with receiving the second frame, a third frame including a fourth set of multiple fields, where the fourth set of multiple fields includes a fourth field including an indication of whether the first AP accepts the second identifier associated with the first AP for the coordinated AP scheme. The operations of 825 may be performed in accordance with examples as disclosed herein. In some implementations, aspects of the operations of 825 may be performed by a frame transmitting component 625 as described with reference to FIG. 6.

In some examples, in 830, the first AP may communicate with one or more STAs in accordance with the coordinated AP scheme and the second frame. The operations of 830 may be performed in accordance with examples as disclosed herein. In some implementations, aspects of the operations of 830 may be performed by a coordinated scheme component 635 as described with reference to FIG. 6.

Implementation examples are described in the following numbered clauses:
Aspect 1: A method for wireless communications by a first AP, comprising: transmitting a first frame comprising a first plurality of fields, wherein the first plurality of fields includes a first field proposing an identifier associated with a second AP for a coordinated AP scheme including the first AP and at least the second AP; receiving, in accordance with transmitting the first frame, a second frame comprising a second plurality of fields, wherein the second plurality of fields includes a second field comprising an indication of whether a second AP accepts the identifier associated with the second AP for the coordinated AP scheme; and communicating with one or more STAs, the second AP, or both in accordance with the coordinated AP scheme and the second frame.
Aspect 2: The method of aspect 1, wherein receiving the second frame comprises: receiving the second plurality of fields via a first element of the second frame; and receiving a third plurality of fields via a second element of the second frame, wherein the third plurality of fields includes a third field proposing a second identifier associated with the first AP for the coordinated AP scheme, the method further comprising: transmitting, in accordance with receiving the second frame, a third frame comprising a fourth plurality of fields, wherein the fourth plurality of fields includes a fourth field comprising an indication of whether the first AP accepts the second identifier associated with the first AP for the coordinated AP scheme.
Aspect 3: The method of any of aspects 1 through 2, wherein the second plurality of fields further includes a third field proposing a second identifier associated with the first AP for the coordinated AP scheme, the method further comprising: transmitting, in accordance with receiving the second frame, a third frame comprising a third plurality of fields, wherein the third plurality of fields includes a fourth field comprising an indication of whether first AP accepts the second identifier associated with the first AP for the coordinated AP scheme.
Aspect 4: The method of any of aspects 1 through 3, wherein the first plurality of fields is included in an element of the first frame that is different than one or more elements of the first frame that correspond to one or more coordinated AP schemes, and the second plurality of fields is included in an element of the second frame that is different than one or more elements of the second frame that correspond to the one or more coordinated AP schemes.
Aspect 5: The method of any of aspects 1 through 3, wherein the first plurality of fields is included as a sub-element of one or more elements of the first frame that correspond to one or more coordinated AP schemes, and the second plurality of fields is included as a sub-element of one or more elements of the second frame that correspond to the one or more coordinated AP schemes.
Aspect 6: The method of any of aspects 1 through 5, wherein transmitting the first frame comprises: transmitting the first plurality of fields via a first element of the first frame, wherein the first plurality of fields includes a third field comprising an indication of an element type associated with the first element, or includes a fourth field comprising an indication of whether the first element is associated with the AP, or with the second AP, or both.
Aspect 7: The method of any of aspects 1 through 6, further comprising: incrementing a counter value associated with transmitting the first frame, the counter value indicative of a quantity of transmissions associated with assigning an identifier to the second AP, wherein the first plurality of fields includes a third field comprising an indication of the counter value.
Aspect 8: The method of any of aspects 1 through 7, wherein receiving the second frame comprises: receiving the second plurality of fields via a first element of the second frame, wherein the second plurality of fields includes a third field comprising an indication of a response type associated with the first element, and wherein the indication of whether the second AP accepts the identifier is in accordance with the response type.
Aspect 9: The method of aspect 8, wherein the response type comprises an indication of an acceptance of an AP identifier for the coordinated AP scheme, an indication of a rejection of an AP identifier for the coordinated AP scheme, or an indication of a second identifier associated with the second AP for the coordinated AP scheme different than the identifier.
Aspect 10: The method of any of aspects 1 through 9, wherein the first field comprising the identifier is associated with at least a portion of a third field associated with one or more association identifiers corresponding to the one or more STAs.
Aspect 11: The method of any of aspects 1 through 10, further comprising: generating a value of the identifier associated with the second AP for the coordinated AP scheme prior to transmitting the first frame, wherein the value of the identifier is different than one or more values associated with the one or more STAs, or the value at least partially matches a basis service set (BSS) color value associated with the second AP, or the value at least partially matches a BSS identifier of the second AP, or any combination thereof.
Aspect 12: A first AP for wireless communications, comprising one or more memories storing processor-executable code, and one or more processors coupled with the one or more memories and individually or collectively operable to execute the code to cause the first AP to perform a method of any of aspects 1 through 11.
Aspect 13: A first AP for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit a first frame comprising a first plurality of fields, wherein the first plurality of fields includes a first field proposing an identifier associated with a second AP for a coordinated AP scheme including the first AP and at least the second AP;
receive, in accordance with transmitting the first frame, a second frame comprising a second plurality of fields, wherein the second plurality of fields includes a second field comprising an indication of whether the second AP accepts the identifier associated with the second AP for the coordinated AP scheme; and
communicate with one or more wireless stations (STAs), the second AP, or both in accordance with the coordinated AP scheme and the second frame.

2. The first AP of claim 1, wherein, to receive the second frame, the processing system is configured to cause the first AP to:
receive the second plurality of fields via a first element of the second frame; and
receive a third plurality of fields via a second element of the second frame, wherein the third plurality of fields includes a third field proposing a second identifier associated with the first AP for the coordinated AP scheme, and wherein the processing system is further configured to cause the first AP to:
transmit, in accordance with receiving the second frame, a third frame comprising a fourth plurality of fields, wherein the fourth plurality of fields includes a fourth field comprising an indication of whether the first AP accepts the second identifier associated with the first AP for the coordinated AP scheme.

3. The first AP of claim 1, wherein the second plurality of fields further includes a third field proposing a second identifier associated with the first AP for the coordinated AP scheme, and the processing system is further configured to cause the first AP to:
transmit, in accordance with receiving the second frame, a third frame comprising a third plurality of fields, wherein the third plurality of fields includes a fourth field comprising an indication of whether first AP accepts the second identifier associated with the first AP for the coordinated AP scheme.

4. The first AP of claim 1, wherein:
the first plurality of fields is included in an element of the first frame that is different than one or more elements of the first frame that correspond to one or more coordinated AP schemes; and
the second plurality of fields is included in an element of the second frame that is different than one or more elements of the second frame that correspond to the one or more coordinated AP schemes.

5. The first AP of claim 1, wherein:
the first plurality of fields is included as a sub-element of one or more elements of the first frame that correspond to one or more coordinated AP schemes; and
the second plurality of fields is included as a sub-element of one or more elements of the second frame that correspond to the one or more coordinated AP schemes.

6. The first AP of claim 1, wherein, to transmit the first frame, the processing system is configured to cause the first AP to:
transmit the first plurality of fields via a first element of the first frame, wherein the first plurality of fields includes a third field comprising an indication of an element type associated with the first element, or includes a fourth field comprising an indication of whether the first element is associated with the AP, or with the second AP, or both.

7. The first AP of claim 1, wherein the processing system is further configured to cause the first AP to:
increment a counter value associated with transmitting the first frame, the counter value indicative of a quantity of transmissions associated with assigning an identifier to the second AP, wherein the first plurality of fields includes a third field comprising an indication of the counter value.

8. The first AP of claim 1, wherein, to receive the second frame, the processing system is configured to cause the first AP to:
receive the second plurality of fields via a first element of the second frame, wherein the second plurality of fields includes a third field comprising an indication of a response type associated with the first element, and wherein the indication of whether the second AP accepts the identifier is in accordance with the response type.

9. The first AP of claim 8, wherein the response type comprises an indication of an acceptance of an AP identifier for the coordinated AP scheme, an indication of a rejection of an AP identifier for the coordinated AP scheme, or an indication of a second identifier associated with the second AP for the coordinated AP scheme different than the identifier.

10. The first AP of claim 1, wherein the first field comprising the identifier is associated with at least a portion of a third field associated with one or more association identifiers corresponding to the one or more STAs.

11. The first AP of claim 1, wherein the processing system is further configured to cause the first AP to:
generate a value of the identifier associated with the second AP for the coordinated AP scheme prior to transmitting the first frame, wherein the value of the identifier is different than one or more values associated with the one or more STAs, or the value at least partially matches a basis service set (BSS) color value associated with the second AP, or the value at least partially matches a BSS identifier of the second AP, or any combination thereof.

12. A method for wireless communications by a first access point (AP), comprising:
transmitting a first frame comprising a first plurality of fields, wherein the first plurality of fields includes a first field proposing an identifier associated with a second AP for a coordinated AP scheme including the first AP and at least the second AP;
receiving, in accordance with transmitting the first frame, a second frame comprising a second plurality of fields, wherein the second plurality of fields includes a second field comprising an indication of whether the second AP accepts the identifier associated with the second AP for the coordinated AP scheme; and
communicating with one or more wireless stations (STAs), the second AP, or both in accordance with the coordinated AP scheme and the second frame.

13. The method of claim 12, wherein receiving the second frame comprises:
receiving the second plurality of fields via a first element of the second frame; and
receiving a third plurality of fields via a second element of the second frame, wherein the third plurality of fields includes a third field proposing a second identifier associated with the first AP for the coordinated AP scheme, the method further comprising:
transmitting, in accordance with receiving the second frame, a third frame comprising a fourth plurality of fields, wherein the fourth plurality of fields includes a fourth field comprising an indication of whether the first AP accepts the second identifier associated with the first AP for the coordinated AP scheme.

14. The method of claim 12, wherein the second plurality of fields further includes a third field proposing a second identifier associated with the first AP for the coordinated AP scheme, the method further comprising:
transmitting, in accordance with receiving the second frame, a third frame comprising a third plurality of fields, wherein the third plurality of fields includes a fourth field comprising an indication of whether first AP accepts the second identifier associated with the first AP for the coordinated AP scheme.

15. The method of claim 12, wherein:
the first plurality of fields is included in an element of the first frame that is different than one or more elements of the first frame that correspond to one or more coordinated AP schemes; and
the second plurality of fields is included in an element of the second frame that is different than one or more elements of the second frame that correspond to the one or more coordinated AP schemes.

16. The method of claim 12, wherein:
the first plurality of fields is included as a sub-element of one or more elements of the first frame that correspond to one or more coordinated AP schemes; and
the second plurality of fields is included as a sub-element of one or more elements of the second frame that correspond to the one or more coordinated AP schemes.

17. The method of claim 12, wherein transmitting the first frame comprises:
transmitting the first plurality of fields via a first element of the first frame, wherein the first plurality of fields includes a third field comprising an indication of an element type associated with the first element, or includes a fourth field comprising an indication of whether the first element is associated with the AP, or with the second AP, or both.

18. The method of claim 12, further comprising:
incrementing a counter value associated with transmitting the first frame, the counter value indicative of a quantity of transmissions associated with assigning an identifier to the second AP, wherein the first plurality of fields includes a third field comprising an indication of the counter value.

19. The method of claim 12, wherein receiving the second frame comprises:
receiving the first plurality of fields via a first element of the second frame, wherein the second plurality of fields includes a third field comprising an indication of a response type associated with the first element, and wherein the indication of whether the second AP accepts the identifier is in accordance with the response type.

20. The method of claim 19, wherein the response type comprises an indication of an acceptance of an AP identifier for the coordinated AP scheme, an indication of a rejection of an AP identifier for the coordinated AP scheme, or an indication of a second identifier associated with the second AP for the coordinated AP scheme different than the identifier.
